(19) United States
(12) Patent Application Publication
(10) Pub. No.: US 2005/0226420 A1
(43) Pub. Date: Oct. 13, 2005

(54) Method and system in a digital wireless data communication network for arranging data encryption and corresponding server

(76) Inventors: Jakke Makela, Turku (FI); Jussi Jaatinen, Vantaa (FI)

Correspondence Address: HARRINGTON & SMITH, LLP, 4 RESEARCH DRIVE, SHELTON, CT, 06484-6212, US

(21) Appl. No.: 10/512,590

(22) PCT Filed: May 9, 2003
(86) PCT No.: PCT/FI03/00360

§ 371 Date: Oct. 25, 2004

(30) Foreign Application Priority Data
May 17, 2002 (SE) 20025024

(51) Int. Cl. H04K 1/00

(52) U.S. Cl. 380/270

(57) ABSTRACT

The invention concerns a method and system in a digital wireless data communication network for arranging data encryption as one-time pad encryption. The data communication network includes at least two terminal equipment, which are used to manage a set of indexed encryption keys and of these the first terminal equipment is at least a transmitter and the second terminal equipment is at least a receiver. Besides the encrypted data, the said encryption key index is transmitted to the receiving terminal equipment. The data communication network also includes a special server terminal equipment, which is arranged to manage and distribute a set of indexed encryption keys to the terminal equipment. The invention also concerns a corresponding server terminal equipment.

The invention concerns a method in a digital wireless data communication network for arranging data encryption as one-time pad encryption, wherein the data communication network includes at least two terminal equipment, wherein the terminal equipment are used for controlling a set of indexed encryption keys and of the terminal equipment the first is at least a transmitter and the second terminal equipment is at least a receiver and wherein the data encryption is adapted to take place at the first terminal equipment in stages, wherein
an encryption key index is chosen,
the data to be transmitted is encrypted by using the encryption key defined by the chosen encryption key index, and
the encrypted data is transmitted to the second terminal equipment
   and wherein correspondingly at the second terminal equipment
the encrypted data is received, and
the encrypted data is decrypted by using the chosen key indicated by the encryption key index.
   The invention also concerns a corresponding system and server terminal equipment.

Wireless communication still lacks a simple way of implementation for achieving a good and secure encryption concept for communication to be carried on between the plenty of terminal equipment. The encryption algorithms used today are often very complicated for their implementation. In addition, the distribution of their related encryption information, such as, for example, encryption keys, is quite problematic and risky.

Encryption protocols representing the known technology are such as PGP (Pretty Good Privacy) and RSA (Rivest-Shamir-Adelman public key encryption). However, their implementation is rather complicated and heavy, for example, for use in a wireless communication environment. In other environments, too, their usability leaves much to be desired.

As the state of the art reference is made to patent publications U.S. Pat. No. 6,021,203 (Microsoft Corporation), WO-01/95558 A1 (Matsushita), U.S. Pat. No. 5,222,137 (Motorola, Inc.) and U.S. Pat. No. 5,483,598 (Digital Equipment Corp.).

Of these publications U.S. Pat. No. 5,483,598 presents a solution based on the use of one-time pad encryption and using a fixed secret key distributed between the sender and the recipient and also a one-time pad, which, however, is generated, for example, from an encrypted message or from an encryption key flow. In fact, the system is vulnerable in this respect, because by analysing an encrypted transmission long enough it may be possible to solve a recursively generated encryption key.

From WO publication 01/74005 (Hammersmith) such a solution based on one-time pad encryption is known, which presents distribution of keys to several terminal equipment communicating in a fixed Internet network. Here the delivery of encryption keys is carried out mainly in connection with the actual communication event. The sender downloads the encryption key from the server and the server delivers the key also to the recipient of the message. Then the sender and receiver communicate with one another using this downloaded encryption key. This kind of 1-to-1 distribution architecture, wherein one key can be used for communication essentially with one party only, is associated, for example, in mobile station environments, with drawbacks and limitations to do with the distribution of encryption keys. This is why the encryption method presented in the publication will function moderately only in communication between two parties, or at least in communication between more parties its implementation would be very heavy in traffic terms, for example, on account of constant encryption key inquiries. When proceeding in this manner, encryption of group communication would require en exponentially increasing number of encryption keys. The number of encryption keys is now also strongly dependent on the size of the group of users.

It is a purpose of this invention to bring about a method and system of a new kind for arranging encryption in traffic of data format, which essentially simplifies the required encryption system and improves the security of key management. The characteristic features of the method according to the invention are presented in claim 1, those of the system in claim 16 and those of the server in claim 19.

The manner of implementing encryption according to the invention has an entirely opposite approach compared with the known technology, because here the algorithm performing encryption may be infinitely simple in its most advantageous form. The infinitely powerful encryption model thus brought about is also very simple to implement. The method and system are not concerned with the implementation of the algorithms to be used in the encryption, which makes it possible advantageously to utilise, for example, already existing encryption algorithms.

In principle, the presented encryption method and system are entirely invulnerable to all encryption analysis. It can be implemented quickly and advantageously, for example, in known cellular networks and even in existing terminal equipment, as it can easily be merged into their communication software.

The method according to the invention is based on the one-time pad encryption mechanism known as such providing communication between terminal equipment with an essentially improved security level and also a secure way of distributing the information used in encryption to the communicating terminal equipment.

The one-time pad encryption mechanism is the only theoretically unbreakable encryption method. The new kind of managing and distributing encryption keys for use in encryption algorithms essentially improves the security level of encryption and makes it entirely unbreakable in principle in comparison with the methods known at present for use in wireless communication. The system according to the invention includes at least one terminal equipment functioning as a server and one or more terminal equipment communicating with one another in a data communication network. Special advantage is achieved with the method according to the invention explicitly in communication between several terminal equipment (1-to-N communication), wherein smooth distribution of encryption keys has been a bottleneck in the implementation of functioning and smooth one-time pad encryption models. The terminal equipment arranged to function as a server administers the use and formation and possibly also the distribution of the encryption information.

In the system, encryption information is updated for the terminal equipment from the server terminal equipment through the data communication network, which encryption information is used by the plenty of terminal equipment in order to encrypt their traffic. Such encryption information may, for example, include encryption keys, according to one embodiment.

According to a first advantageous embodiment, the encryption may be carried out as complete one-time pad encryption, where an encryption key already used once in the communication between the terminal equipment is not used a second time. In this way a very high security level is achieved for the encryption.

According to another advantageous embodiment, the encryption may also be carried out as partly one-time pad encryption. Hereby the same encryption key can be used several times in the communication between plenty of terminal equipment, but the security level will not suffer significantly from this. With this embodiment an advantage is achieved, for example, in such a situation, where the server terminal equipment administering the encryption keys is temporarily unavailable to the terminal equipment carrying out communication. Another additional achieved advantage is that the data transmission to do with encryption information is reduced significantly and that there is less need for memory capacity for the encryption information to be stored at the terminal equipment.

According to an advantageous embodiment, the updating of encryption information may be done in a wireless local area network even entirely automatically, whereby no steps need to be taken for this by the user of the terminal equipment. The embodiment is especially advantageous, for example, for encrypting communication taking place in a limited group. Hereby the updating of encryption information can be controlled by a server terminal equipment, which transmits encryption information to the terminal equipment at its own discretion. On the other hand, the terminal equipment may also download encryption information spontaneously depending on their need for updating at each time.

Traditionally, the distribution of encryption keys has been the Achilles heel of one-time pad encryption. In the method according to the invention it is also possible to use even powerful encryption for the encryption of encryption keys when transferring them from the server terminal equipment to the terminal equipment. On the other hand, transferring of keys without encryption is also possible, if the distribution of keys is arranged, for example, in such a wireless local area network, where it is possible to control the users having access to its carrier area.

Examples of wireless data communication networks where the invention may be applied are solutions based on CDMA (Code Division Multiple Access), TDMA (Time Division Multiple Access) and FDMA (Frequency Division Multiple Access) technologies and sub-specifications based on these as well as technologies still being developed.

Another advantageous object of application for the method and system according to the invention, besides wireless communication, are mass memories, in connection with which huge quantities of sensitive information are processed.

Other characteristic features of the method, system and server terminal equipment according to the invention emerge from the appended claims and more advantages that can be achieved are listed in the description part.

The method, system and server terminal equipment according to the invention, which are not limited to the embodiments presented hereinafter, are described in greater detail by referring to the appended figures, wherein

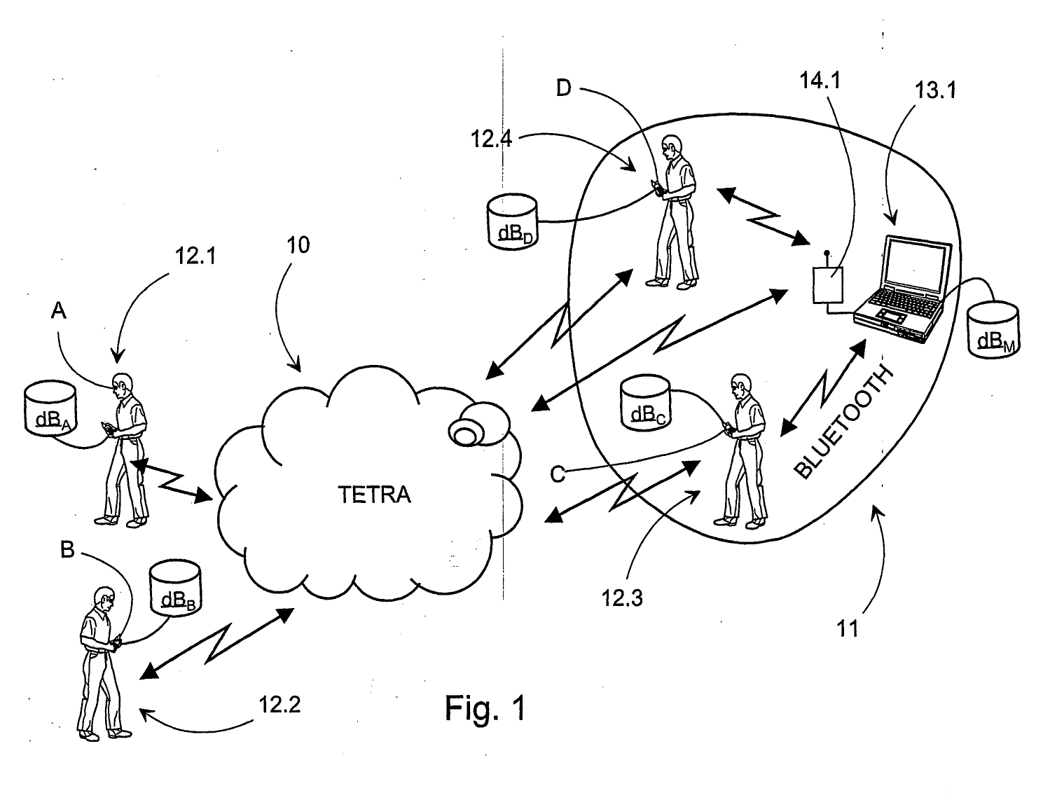

FIG. 1 is a schematic view of an example of an embodiment of the system according to the invention,

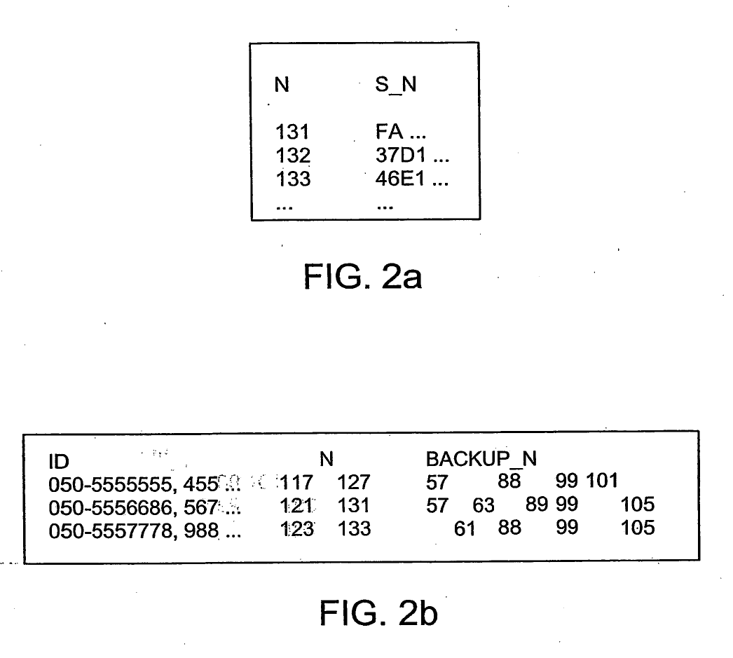

FIGS. 2a and b show examples of data structures,

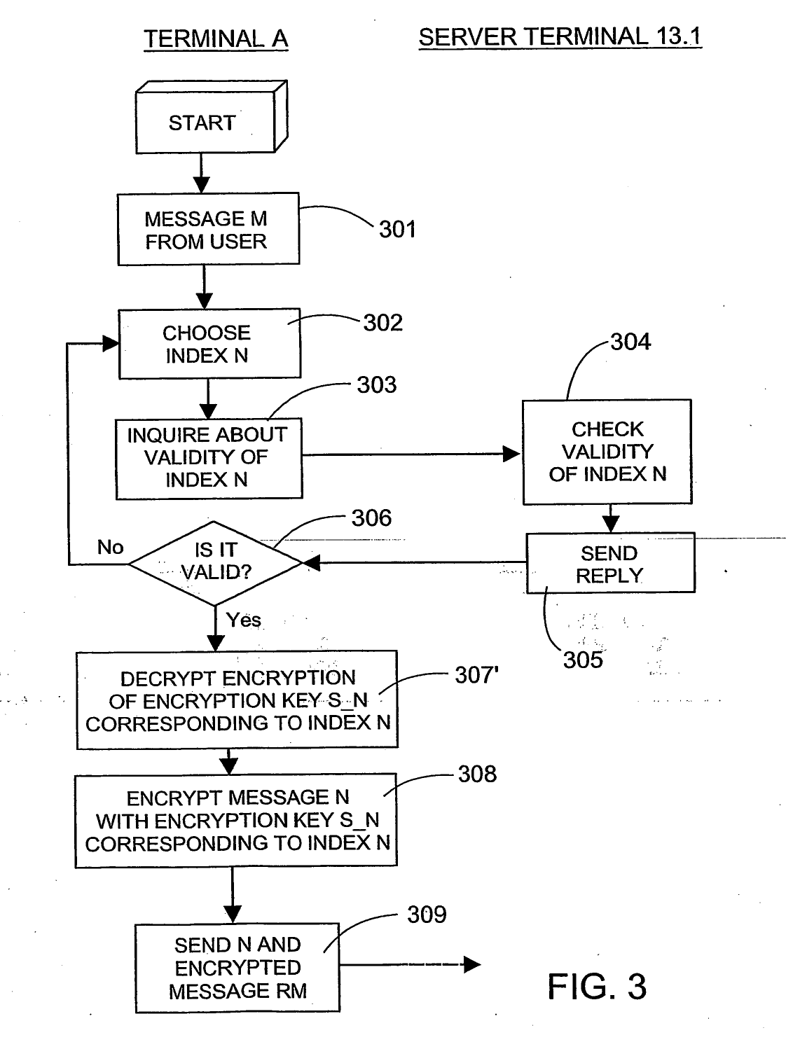

FIG. 3 is a flow diagram showing an example of steps in a first embodiment of the method according to the invention in a terminal equipment transmitting with complete one-time pad encryption,

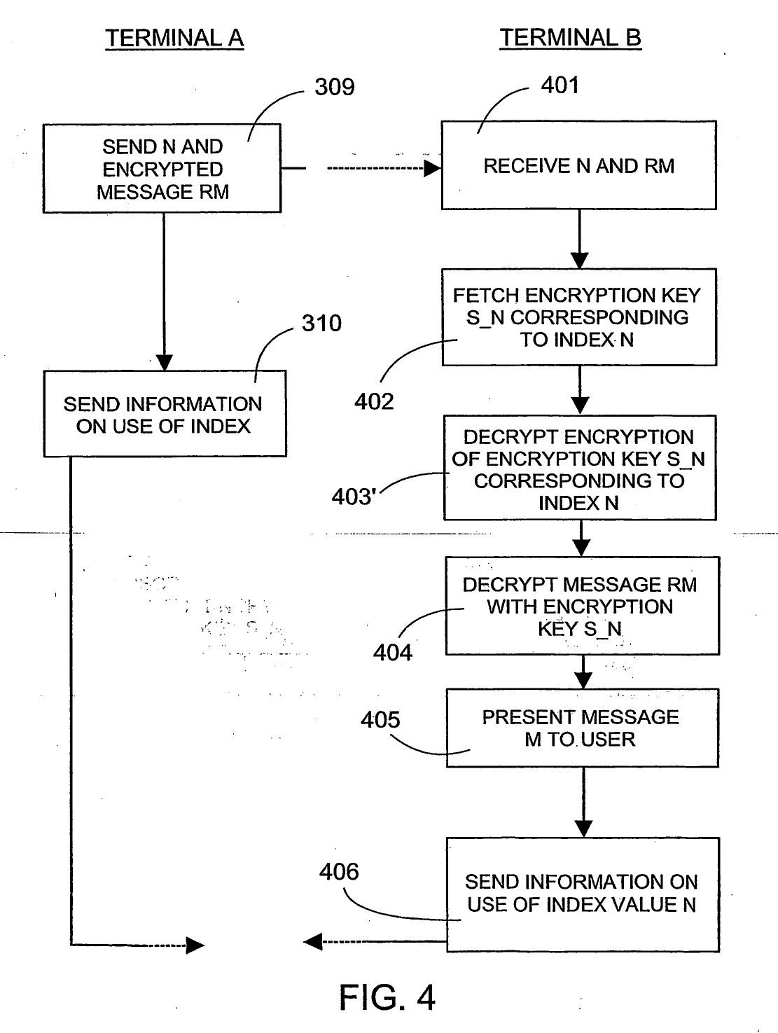

FIG. 4 is a flow diagram showing an example of steps in a first embodiment of the method according to the invention in a terminal equipment receiving with complete one-time pad encryption,

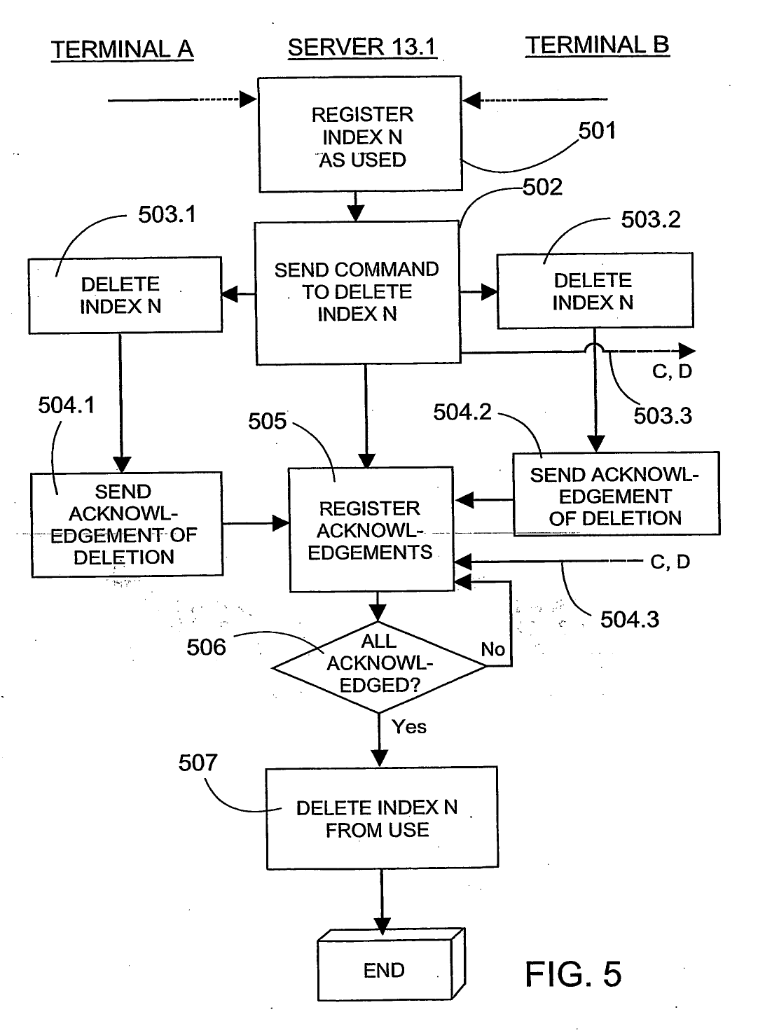

FIG. 5 is a flow diagram showing a first example of steps in the embodiment shown in FIGS. 3 and 4 in connection with updating of encryption information,

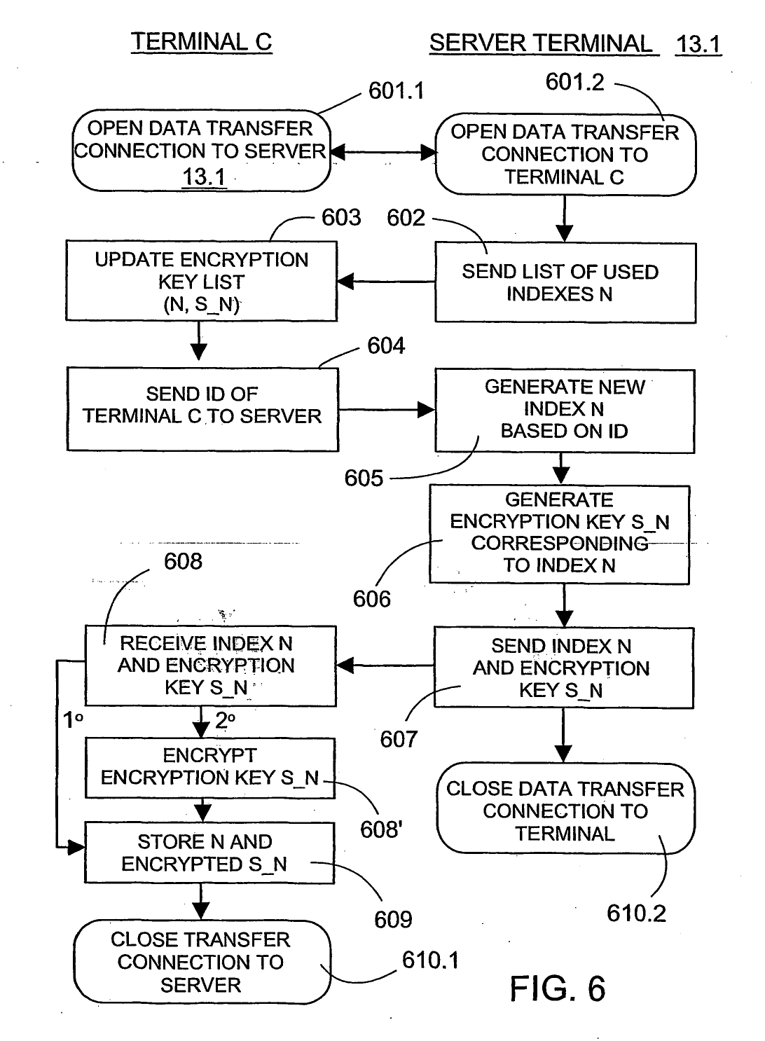

FIG. 6 is a flow diagram showing another manner of implementation of encryption information updating in complete one-time pad encryption,

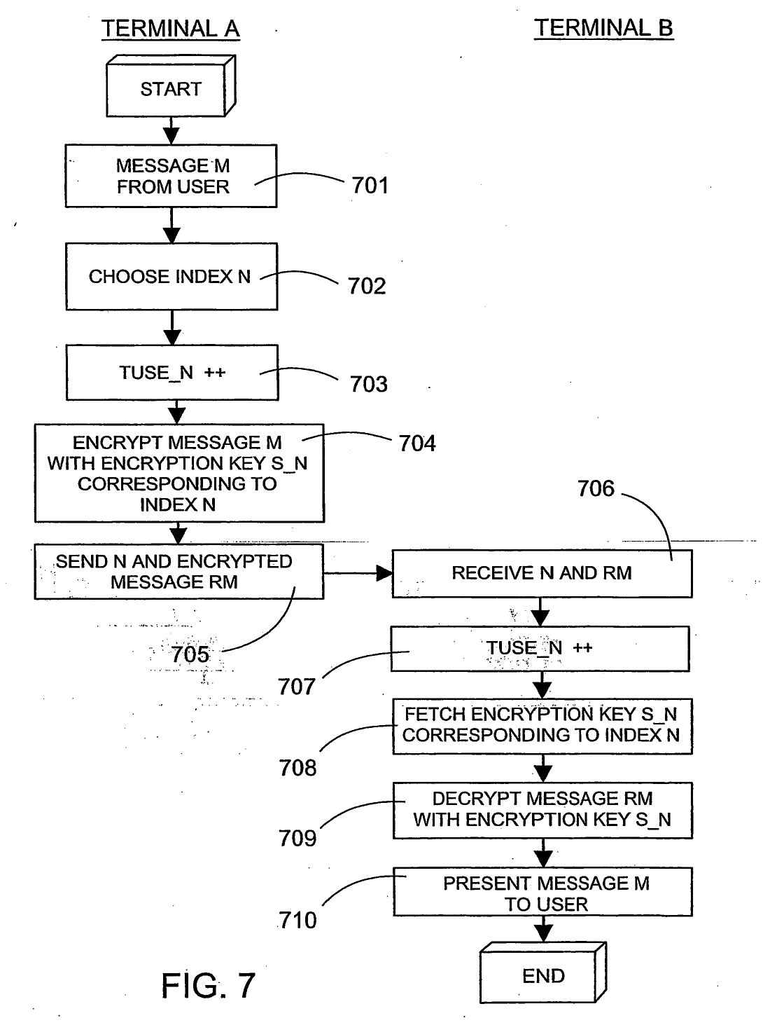

FIG. 7 is a flow diagram showing an example of steps in another embodiment of the method according to the invention in a terminal equipment transmitting and receiving with partly one-time pad encryption,

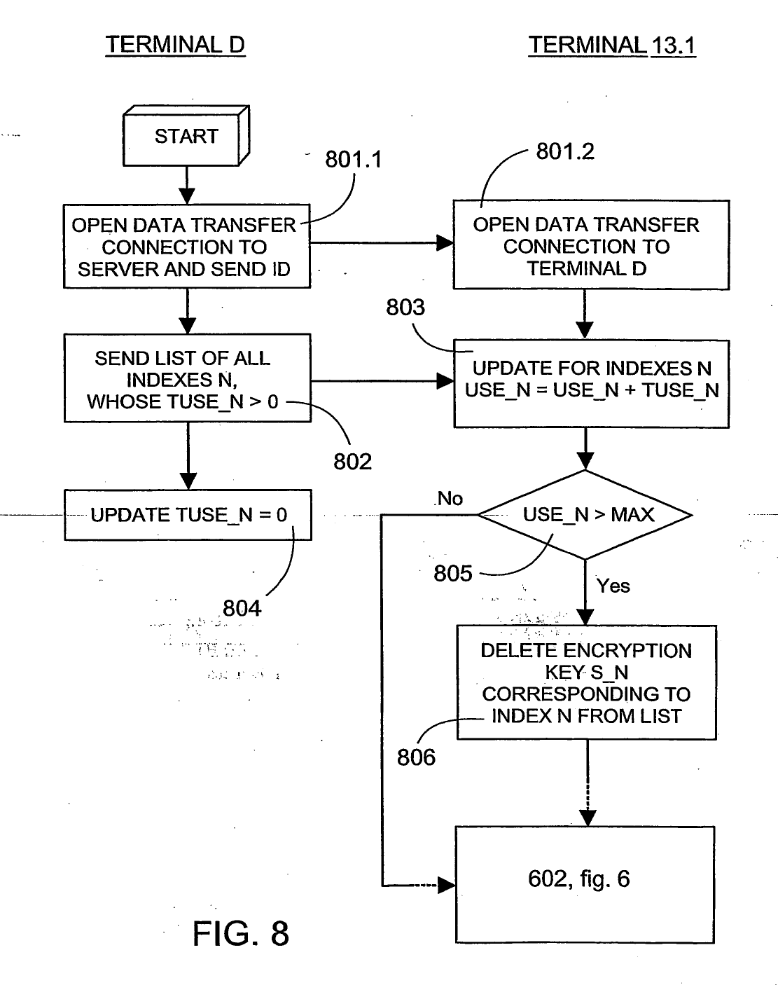

FIG. 8 is a flow diagram showing another example in partly one-time pad encryption in connection with updating of encryption information,

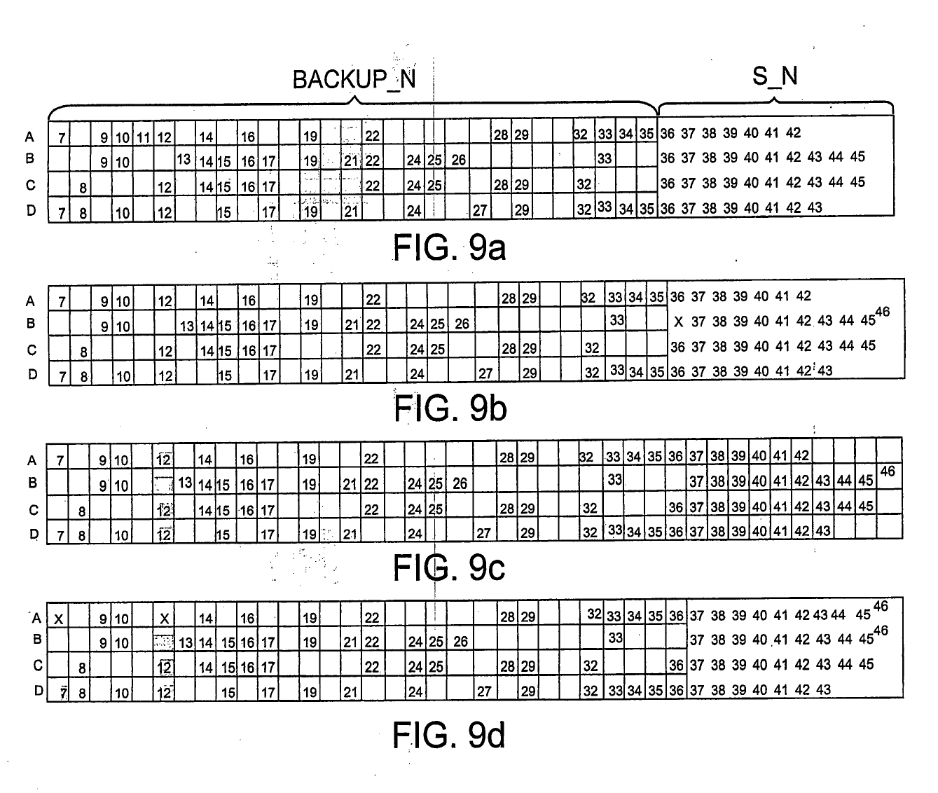

FIGS. 9a-d show an example of a server database in updating of encryption keys, and

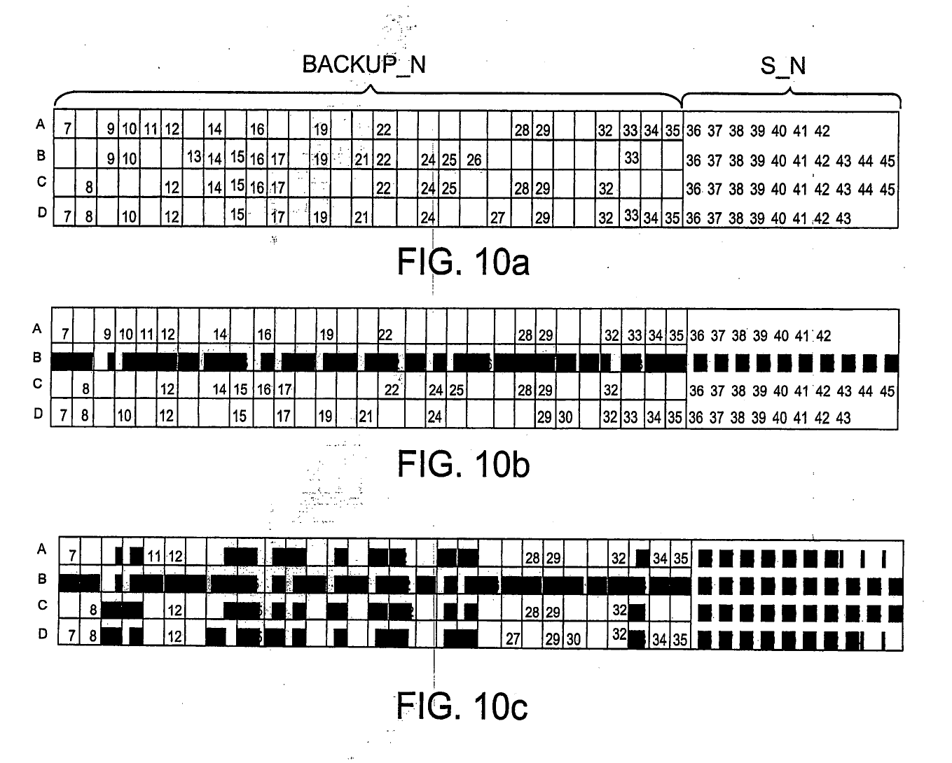

FIGS. 10a-c show an example of encryption key management after a terminal equipment has lost its security.

FIG. 1 is a schematic view of an example of an embodiment of the system according to the invention. The system and method according to the invention concern arranging of data encryption in a digital wireless data communication network 10, 11 in accordance with the one-time pad encryption model. The data communication network 10, 11 may be a wire-line network, such as, for example, an IP network (for example, Internet, Intranet, LAN) or wireless (for example, WLAN, CDMA, TDMA, FDMA, Bluetooth).

The data communication network 10, 11, which is wireless in the case shown as an example, includes at least two terminal equipment A-D communicating with one another, of which one of the terminal equipment, A, functions at least as a transmitter, whereas the other terminal equipment B functions at least as a receiver. Communication between terminal equipment A, B may be, for example, directly in data format, such as SMS messages or electronic mail or indirectly in data format, such as, for example, coded speech.

Furthermore, the data communication network 10, 11 includes at least one special server terminal equipment 13.1 equipped with connection devices 14.1. For this a database dB_{M} is arranged for storing of encryption information, such as indexed encryption keys. Furthermore, at the server terminal equipment 13.1 the ID identifier of the terminal equipment A-D subordinated to it is stored therein, besides the said indexed encryption keys. There may also be several server terminal equipment, whereby synchronization of their databases dB_{M} may be implemented, for example, by some known method (not shown).

At the said server terminal equipment 13.1 a functionality is also arranged, such as, for example, program or a corresponding set of commands to be carried out in a processor environment, which commands are used for managing and distributing these indexed encryption keys to other terminal equipment A-D based on the established criterion. The server terminal equipment 13.1, which the invention thus also concerns, may be, for example, a PC or some other such, like the terminal equipment A-D communicating with one another in the data communication network 10, 11, provided that resources are arranged for it for managing, generating and distributing the said indexed encryption keys.

The server terminal equipment 13.1 is preferably arranged in such a way that it is easy to supervise its physical security. One such way of locating the server terminal equipment 13.1 is a well-protected, preferably locked place (not shown), because any data break-in therein would cause loss of the encryption model. The place is, for example, on the premises of the company, organisation, user group or such carrying out the communication, where the members of the communicating group use advantageously to visit regularly. A coffee or negotiation room or such is presented as an example of such a room.

The terminal equipment A-D also include devices for storing and administering a set of indexed encryption keys, devices for doing data encryption and for decrypting the encryption by chosen algorithms and by an encryption key according to the encryption key index and at least one carrier interface for receiving the indexed encryption keys from the data communication network 11. For the indexed encryption keys a database dB_{A}, dB_{B}, dB_{C}, dB_{D} is arranged in the memory area of terminal equipment A-D. Administration of the encryption keys is done in the processor environment of the terminal equipment A-D by commands performed by a program. The method according to the invention sets no limitations for the algorithms used in the encryption, but it may preferably be any one based on a random encryption key. Thus, the encryption algorithm may even be quite public, such as, for example, XOR summing.

According to an advantageous embodiment, flexible distribution of the indexed encryption keys to terminal equipment C, D takes place over a wireless local area network connection 11, such as, for example, WLAN (Wireless Local Area Network) or Bluetooth or over some other local data transmission channel (IrDA, RS-232). The updating of keys may be automated, by using, for example, Bluetooth technology, whereby it is always performed when the users 12.3, 12.4 together with their terminal equipment C, b pay a visit to this “updating node” 11. Distribution of encryption keys may be performed without encryption, if it is possible to make sure that no external quarters have access to the data communication network 11 (for example, Bluetooth). Furthermore, also if the distribution of encryption keys takes place by way of an IR port or a data cable in a closed space, it is not necessary to encrypt the keys.

The encryption keys may also be encrypted when transferring them from the server terminal equipment 13.1 to the terminal equipment A-D. The algorithm for use in the encryption may be chosen rather freely, depending, for example, on the physical conditions.

As one way of performing encryption in the transfer of encryption keys the use of one-time pad encryption may be mentioned, whereby the encryption method is used twice in a sense. Hereby the encryption of keys is carried out with the chosen algorithm, wherein another list of encryption keys is used, which is especially intended for transfer of keys. The keys of this list again may be downloaded in terminal equipment A-D from the server terminal equipment 13.1 only through a data cable.

FIG. 2a shows an illustrating example of a running set of indexed encryption keys S_N stored at the server terminal equipment 13.1. Indexes N to be presented as integer numbers are in the first field of the record, while the encryption keys S_N corresponding to index N are in the second field and are, for example, in hexadecimal form.

FIG. 2b shows an example of a management database dB_{M} located in server terminal equipment 13.1. The record, which corresponds to one terminal equipment A-D, is formed by the terminal equipment A-D ID field (for example, the subscriber identifier and/or the terminal equipment IMEI (International Mobile Equipment Identity) code, the indexes N of the (active) encryption keys S_N last downloaded at terminal equipment A-D and the indexes BACKUP_N of the backup encryption keys located at the terminal equipment A-D. The ID field must unambiguously identify the terminal equipment A-D and its user 12.1, 12.2, 12.4, 12.5. For each terminal equipment A-D only a predetermined number of these active encryption keys S_N can be stored (for example, 40).

In the following different embodiments of the method according to the invention will be described, of which there are at least two different types in principle. Of these only one can be used at a time in the same terminal equipment group A-D, depending on the participants in the system.

FIG. 3 is a flow diagram showing an example of a first embodiment of the method according to the invention with a transmitting terminal equipment A. The embodiment is implemented as a complete one-time pad encryption, wherein the chosen indexed encryption key S_N is used only one time, whereupon the used encryption key S_N is deleted from every terminal equipment A-D of the system. With this method of implementation a very high security level is achieved for the encryption. However, the implementation method requires sufficient memory capacity of the terminal equipment A-D, because the lists of encryption keys to be stored in them may hereby become very long.

The user 12.1 of terminal equipment A produces in some manner a message M, which is to be transmitted and which may be, for example, a SMS or electronic mail message (301). When message M has been produced and user 12.1 in the established way notifies terminal equipment A that he wishes to perform the transmission encrypted explicitly with one-time pad encryption, terminal equipment A will according to one embodiment choose encryption key index N from its indexed encryption key database dB_{A} arranged in its memory (302).

According to an advantageous embodiment, after the choice of encryption key index N terminal equipment A checks at server terminal equipment 13.1 the usability of the chosen index N, for example, as a SMS message (303) through data communication network 10. The embodiment may also be implemented without any checking procedure (303-306), because in this case the encryption key S_N is used only once. Furthermore, if in the method according to the invention updating of encryption keys S_N is done essentially simultaneously for all terminal equipment A-D, then such a checking procedure (303-306) is not even necessary. However, if some other terminal equipment B-D would happen to transmit almost simultaneously with terminal equipment A a message encrypted with the same encryption key S_N and server terminal equipment 13.1 has not had the time to do the said updating concerning encryption key S_N and send the relating cancelling commands (presented hereinafter) to terminal equipment A-D, then this checking procedure (303-306) is an advantageous precautionary measure in the described embodiment.

Server terminal equipment 13.1 checks the usability of index N in its own main database dB_{M} (304) and sends a reply to the inquiring terminal equipment A (305). Terminal equipment A receives the information and based on this it either accepts the encryption key index N of its choice or chooses a new index N from its database dB_{A} for checking in a similar manner (306).

According to another more advantageous embodiment, the procedure of choosing (302-305) the encryption key index N, can be performed in such a way that the user 12.1 of the transmitting terminal equipment A indicates the recipient B of the message M in some manner (302), of which information is then relayed to server terminal equipment 13.1 (303). It should be noticed that the message may also have several recipients B-D. Server terminal equipment 13.1 chooses from its database dB_{M} an index N corresponding to the encryption key S_N suitable for transmitter A and for recipient B (304) and sends information about this to the transmitting terminal equipment A (305). This indirect embodiment is considerably more advantageous as regards the choice of index to be made directly at terminal equipment A, because the traffic volume is hereby significantly smaller (not shown).

When a usable index N is found, terminal equipment A performs encryption of message M using encryption key S_N corresponding to the index N just chosen for generation of the encryption bit stream (308). If encryption key S_N is stored encrypted in database dB_{A}, its encryption is decrypted (307′). Encryption of the message M to be transmitted may be performed with encryption algorithms known as such, which can be run by the processor devices of terminal equipment A.

After the encryption the encrypted message RM and index N of the encryption key S_N used in the encryption are transmitted by ways of data communication network 10 to the terminal equipment 12.2 of one or more recipients B of the message (309).

FIG. 4 is a flow diagram showing an example of a first embodiment of the method according to the invention with a receiving terminal equipment B. The flow diagram shown in FIG. 3 continues in FIG. 4. Terminal equipment B receives message RM and index N in the known manner (401). Terminal equipment B fetches an encryption key S_N corresponding with index N from its own indexed key database dB_{B} (402) and decrypts the encrypted message RM with the fetched encryption key S_N using an encryption method of a corresponding kind (404). If encryption key S_N is encrypted, its decryption is performed before it is used (403′). Message M is shown to user 12.2 of terminal equipment B, for example, on the display, if the message is the SMS message used in the example (405).

Immediately after terminal equipment A has, for example, sent message M to terminal equipment B (309) and/or terminal equipment B has decrypted the encryption of message M (404), these in the method according to the embodiment will send information on the use of the encryption key S_N corresponding with index N to server terminal equipment 13.1 (310, 406).

FIG. 5 is a flow diagram showing an example of measures taken in connection with updating of encryption information with the embodiment shown in FIGS. 3 and 4. Server terminal equipment 13.1 identifies terminal equipment A, B sending the used index N, receives the used encryption key index N and registers it as used (501). Then server terminal equipment 13.1 sets for the concerned index N a strikethrough flag at all terminal equipment A-D in its main database dB_{M}. A command is sent to all terminal equipment A-D to delete the corresponding encryption key index N from their indexed key databases dB_{A}, dB_{B}, dB_{C}, dB_{D} (502).

Terminals A-D receive the command to delete index N and carry out the steps for deleting index N and the corresponding encryption key S_N irrevocably from their database dB_{A}, dB_{B}, dB_{C}, dB_{D} (503.1-503.3). Terminals A-D also send an acknowledgement to server terminal equipment 13.1 of the deletion of index N (504.1-504.3), which registers acknowledgements (505, 506). When the deletion has been acknowledged by all terminal equipment A-D receiving the deletion command, server terminal equipment 13.1 finally deletes the encryption key S_N corresponding to index N also from its own main database dB_{M} (507).

The embodiment presented above requires that deletion commands be sent to every terminal equipment A-D (502) and in consequence of their implementation acknowledgement to be sent from terminal equipment A-D to server 13.1 after the deletions (504.1-504.3). This may possibly result even in heavy traffic. If one or more terminal equipment A-D are unavailable to data communication network 10, 11, then synchronization of encryption key lists dB_{A}, dB_{B}, dB_{C}, dB_{D} may also in this case become problematic. In principle, if server terminal equipment 13.1 is not in use, then so are also the other communicating terminal equipment A-D at least after they run out of active encryption keys.

FIG. 6 is a flow diagram showing another way of implementation for carrying out updating of encryption information. In this case, the transmission-reception procedure shown in FIGS. 3, 4 and 5 ends with the transmission of information to server terminal equipment 13.1 on the use of index N (310, 406) and with its registration at server terminal equipment 13.1 (501). In this embodiment, the choice steps or the steps of checking the usability of index N as shown in FIG. 3 (302-306) are of an essential importance.

In this embodiment, the updating of indexed encryption keys S_N used in complete one-time pad encryption is performed in accordance with the established criterion either at the request of terminal equipment A-D or in an automated manner by server terminal equipment 13.1. This is preferably done over a wireless local area network connection 11, for example, at the time when user 12.1, 12.2, 12.3, 12.4 arrives with his terminal equipment A-D on the premises of the business organisation or in some other controlled area.

Terminal equipment C opens a data communication connection with server terminal equipment 13.1 and vice versa (601.1, 601.2). Server terminal equipment 13.1 sends to terminal equipment C a list of the used encryption key indexes N, which the deletion command concerns (602).

Terminal equipment C receives the list of encryption keys, which the deletion command concerns, and updates its own database dB_{C} in accordance with the received data (603). It is essential in connection with the updating, that the used encryption keys S_N are deleted permanently from the database dB_{C} of terminal equipment C. Terminal equipment C will notify if this was not done even as the connection was set up (601.1, 601.2), its own identity symbol ID (604) and at the same time acknowledges the deletions it has made in its database dB_{C}. Server terminal equipment 13.1 generates with its arranged software indexed encryption keys S_N into its own main database dB_{M} based on the identity information ID it has received into its record corresponding to terminal equipment C, as many as there is space in the database dB_{C} of terminal equipment C for active indexed encryption keys S_N (605, 606) or based on some other advantageous criterion.

One example of forming such a criterion is that server terminal equipment 13.1 estimates the number of encryption keys used by terminal equipment A-D and based on this information it distributes encryption keys to each terminal equipment A-D according to their consumption of encryption keys. For this reason, different terminal equipment A-D may have a different number of encryption keys in their memories. Thus, server terminal equipment 13.1 may optimize the number of encryption keys, for example, according to the size of the user group and frequency of use. Hereby, for example, if there are many terminal equipment, but encrypted communication takes place seldom between them, it is sufficient to distribute only a few encryption keys at a time to each terminal equipment.

At some stage of the procedure server terminal equipment 13.1 performs a check in its database dB_{M} to find if in connection with the updating of terminal equipment C such encryption keys occurred, which were set for deletion and concerning the deletion of which an acknowledgement would have arrived from all terminal equipment A-D. If such are found, an irrevocable deletion of these encryption keys is carried out at server terminal equipment 13.1 (not shown).

After the generation of indexes N and corresponding encryption keys S_N and the storing in database dB_{M}, server terminal equipment 13.1 sends indexed encryption keys S_N to terminal equipment C (607), which receives them correspondingly (608). Terminal equipment C stores the indexed encryption keys S_N it has received in its own database dB_{C} (1°, 609). As many encryption keys S_N are preferably downloaded at one updating time as is possible within the memory resources of terminal equipment C. This is done to compensate for the fact that although terminal equipment A-D would come very seldom for downloading of encryption keys S_N, it would still have enough encryption keys S_N for carrying out the communication. On the other hand, server terminal equipment 13.1 may also optimize the number of encryption keys to be downloaded at terminal equipment C in accordance with the established criteria.

According to an advantageous embodiment, terminal equipment C may also encrypt the encryption keys S_N it has received, for example, with a code set by user 12.3 or with a PIN (Personal Identity Number) identifier, which is fetched from the SIM (Subscriber Identity Module) card without any steps taken by user 12.3 (2°, 608′). Correspondingly, before performance and/or decryption of the data encryption the encryption of encryption keys S_N must hereby be decrypted. The updating procedure is completed by closing down the connections from terminal equipment C to server terminal equipment 13.1 and vice versa (610.1, 610.2).

After stage (610.1), terminal equipment C may send a list of encryption key indexes N to be deleted to the established terminal equipment D, which updates its own database dB_{D}. Correspondingly, if terminal equipment D visits server 13.1 to fetch the updated list of encryption key indexes, it will relay it to terminal equipment C. In this way it is possible to reduce further the number of necessary updating communication (not shown).

In the embodiment the data transmission relating to the use and updating of encryption keys S_N can be kept at a moderate level. At server terminal equipment 13.1 a strikethrough flag can be set, and the information on the use of encryption keys S_N is stored at server terminal equipment 13.1 only. The index list of encryption keys S_N to be deleted is only sent when terminal equipment A-D starts the updating delivery of encryption keys.

Such an advantage is also achieved with the embodiment that two terminal equipment A, B may communicate with each other even in such a case when they fail to establish a connection with the server terminal equipment 13.1. However, the security of the system is hereby poorer, because the encryption key may then already be used. In fact, advantageous situations for using this mode are emergency situations in particular, such as a situation where the encryption infrastructure has broken down.

FIG. 7 is a flow diagram showing an example of another embodiment of the method according to the invention with a transmitting and receiving terminal equipment A, B. In this embodiment, encryption is carried out as partial one-time pad encryption, where the same encryption key S_N may be used at least twice. An example of such repeated use, besides the encryption of messages presented above, is encryption of a voice call by using a symmetrical algorithm.

In partial one-time pad encryption the same encryption keys S_N may be used several times. User 12.1 uses terminal equipment A to produce, for example, a SMS message (701). Further, terminal equipment A chooses index N from its database dB_{A} (702). In this connection it is also possible to perform the check or selection procedure of index N shown in FIG. 3 (302-306), if this is necessary or possible. Now every terminal equipment A-D maintains in order to avoid problems caused by synchronization or downtime of server terminal equipment 13.1, cycle information TUSE_N of encryption keys S_N, which these have used without any acknowledgement made to server terminal equipment 13.1. Hereby information is also maintained at server terminal equipment 13.1 on the total cycles USE_N of the encryption keys.

As terminal equipment A chooses index N, the cycle variable TUSE_N of the individual terminal equipment is increased (703). The encryption of message M, the transmission to terminal equipment B and the reception there all take place in the manner described in the foregoing (704-706). The terminal equipment B may also be used to increase the corresponding cycle variable TUSE_N (708). The remaining stages, such as the decryption of message M (708-709) and its presentation to user 12.2 (710) may proceed in a corresponding manner as in the complete one-time pad embodiment described above.

With the partial one-time pad encryption embodiment the advantage is achieved that the synchronization of the databases dB_{A}, dB_{B}, dB_{C}, dB_{D} of terminal equipment A-D is without problems and the need for memory capacity of databases in the terminal equipment A-D is considerably smaller than in complete one-time pad encryption.

FIG. 8 is a flow diagram showing an example of updating of the encryption information for the partial one-time pad encryption shown in FIG. 7.

When a connection is possible from the terminal equipment D to be updated to server terminal equipment 13.1, it is set up in both directions in the known manner (801.1, 801.2). Terminal equipment D transmits the values of one or more of its indexes TUSE_N with the established criterion to server terminal equipment 13.1 (802) and sets them at zero (804). The said criterion may be, for example, TUSE_N>0.

At the server terminal equipment 13.1 the total number of cycles USE_N of the corresponding one or more indexes N is increased by the received TUSE_N value (803). If USE_N exceeds the limit value MAX (805) established for it, a strikethrough flag is set for index N in order to delete it from the list of encryption keys (806). Thereupon and even in the case that the maximum cycle condition is not fulfilled, it is possible to proceed, for example, in the manner shown in FIG. 6 starting from stage (602).

With this embodiment an advantage is achieved in that it is not necessary to update all terminal equipment A-D after the use of each encryption key S_N. Although the same encryption key S_N may hereby be used several times, the security level of the encryption method will not suffer significantly, because a limited value may be established for the number of repetitions of the encryption keys S_N, such as, for example, TUSE_N<4. However, repetition of the encryption keys S_N may make possible a partial decryption of the individual key S_N by statistic methods (for example, by studying the differences between messages), but even in the worst case it is then possible to decrypt only TUSE_N messages. Thus, decryption of one encryption key S_N will not damage the security of the system as a whole. If desired, TUSE_N=1 may be established, for example, for every third key S_N, whereby the most sensitive messages may be sent by using these keys and in this way make sure that no repetition of keys S_N will take place in these cases.

In the following, management of encryption keys with the server terminal equipment 13.1 will be explained as a possible embodiment. With the software arranged at server terminal equipment 13.1 the aim is in every cycle of encryption key S_N generation to bring about the maximum number of active encryption keys S_N, which are thus distributed to the terminal equipment A-D. In addition to this, at the server terminal equipment 13.1 all permutations of the remaining encryption keys are maintained as BACKUP keys in database dB_{M}. These can preferably be arranged as a Hash data structure. Hereby at least one encryption key always exists for use in the communication between all terminal equipment and several encryption key pairs exist for some terminal equipment pairs. It is also possible to store more than one version of each permutation, but the BACKUP list will then grow large in size.

FIG. 9a shows a situation by way of example of an active encryption key list S_N and a BACKUP list, which lists are stored at server terminal equipment 13.1 and form a part of database dB_{M}. It should be noted that the example is not concerned with actual encryption keys S_N but with the indexes N corresponding to these. Each line corresponds to one terminal equipment A-D. The BACKUP keys BACKUP_N are in this situation in the early end of the list and they are followed by active, keys S_N. It should be noted that the set-up may also be the other way round, because the list is arranged as a running list in principle. Hereby, when the list is “full”, generation of active keys S_N will again start from its beginning. In the said situation, the indexes of terminal equipment A's BACKUP keys are BACKUP_N={7, 9, 10, 11, 12, 14, 16, 19, 22, 28, 29, 32, 33, 34, 35} while the indexes of the actual active keys are N={36, 37, 38, 39, 40, 41, 42}.

FIG. 9b shows an example, when terminal equipment B is in an updating connection with server terminal equipment 13.1. New encryption keys S_N are generated each time when server terminal equipment 13.1 is in connection with terminal equipment B. In this example, the number of active encryption keys is limited to 10. In this case, server terminal equipment 13.1 generates for terminal equipment B one new encryption key S_N, whose N=46. Generally speaking, it is possible and advantageous to generate as many keys S_N as possible within the maximum number of active keys S_N. In order to keep the number of active encryption keys S_N within the established limitation (≦10), one of these keys must be destroyed. In this case the key to be destroyed is the oldest one of the active keys, that is, key 36, which is now the active key S_N for terminal equipment A, C, D.

FIG. 9c shows the following stage, where the BACKUP list is searched preferably for the oldest BACKUP key as the common key for terminal equipment A, C, D. Nothing prevents one from also choosing some other key meeting the said criterion, but this oldest key is the best one, because hereby the list of encryption keys can be arranged as a circular and running list, reducing the terminal equipment A-D need for memory capacity for storing keys.

For the chosen key, whose N=12, a strikethrough flag is set at server 13.1 and a deletion command directed at it is also transmitted to all terminal equipment A, C, D. It should be noted, however, that there is no certainty for terminal equipment A, C, D as regards the implementation of deletion until the concerned terminal equipment A, C, D is once again updated by server terminal equipment 13.1. However, this key 12 should no longer be used for encryption of the communication of terminal equipment A, C, D.

FIG. 9d shows a situation, where terminal equipment A is now the one in connection with server 13.1 for updating of its key list. For the terminal equipment a new key N=46 is downloaded, and at the same time the success of deletion of key N=12 is ensured. The list of active keys may be transferred to start with key 37, whereby the BACKUP list is changed correspondingly. The BACKUP list is examined for encryption keys for terminal equipment A and it is searched for duplicate occurrences of encryption keys. It is found that 7, 34, 35 are common BACKUP keys for the terminal equipment pairs AD. It is hereby most advantageous to set a strikethrough flag for key 7, to delete it from terminal equipment A and to leave keys 34 and 35 remaining in storage.

The encryption protocol according to the invention is made unique by the fact that no capacity for one-time pad encryption is lost, although one or more terminal equipment disappear, are stolen or have their security status broken down in some other way. This is made possible by the use of the above-mentioned BACKUP keys. Although the lists of encryption keys must be updated as quickly as possible in such a situation, it is still possible that the other terminal equipment can continue with their secured data communication at least for some time.

When the security level of some terminal equipment suffers essentially, for example, because terminal equipment B is stolen, the encryption keys S_N actively in use by terminal equipment B, which has lost its security, can be set at server terminal equipment 13.1 for deletion from use by the other terminal equipment A, C, D. Hereby those BACKUP keys (FIG. 2b) stored in terminal equipment A, C, D, which have already been certainly deleted from terminal equipment B, which has lost its security status, are put into use for a time until new active encryption keys S_N have been generated and updated for terminal equipment A, C, D.

FIGS. 10a-10c show an example of such a case, where one terminal equipment A-D loses its data security because, for example, it is stolen or lost. FIG. 10a shows the initial situation. If terminal equipment B loses its security status, then the active keys and BACKUP keys stored therein must be deleted immediately from use by the other terminal equipment A, C, D (FIG. 10b).

It is seen in FIG. 10c that terminal equipment A, C, D can still continue at least to some extent with their secured communication. The BACKUP keys common to all terminal equipment A, C, D are 12, 29 and 32. Keys common to terminal equipment A and C are 7, 34 and 35, while the key common to terminal equipment C and D is 8. There is now no active list and it must in fact be generated as soon as possible.

However, there is always a small number of BACKUP keys in practice. It is also possible though that some terminal equipment A-D runs out of active encryption keys S_N even in quite ordinary communication. Then a solution could be to allow use of BACKUP key pairs in the communication between terminal equipment A-D.

The size of the memory space to be reserved at terminal equipment A-D for the encryption keys S_N depends both on the memory capacity provided by terminal equipment A-D and on several factors, such as for example, how often the system is used and how often terminal equipment A-D are brought in for updating on an average, so it may even vary much.

Such an advantage is especially achieved with the invention that the disappearance, theft or other broken security of one or more terminal equipment A-D will not result in a final loss of data security for the user 12.1, 12.2, 12.3, 12.4 (as would happen in the case of disappearance of a terminal equipment equipped with a private PGP key), because a new encryption key can be generated in a simple way. For this reason, the encryption model according to the invention is well suited for mobile terminal equipment, which are easily lost or stolen.

According to one more advantageous embodiment, updating of encryption keys S_N for terminal equipment A-D may be done in such a way that they are not necessarily given all the encryption keys S_N generated by server terminal equipment 13.1. Hereby one or more encryption keys S_N may not be distributed based on an established criterion. One such criterion could be such that, for example, after each encryption key index N divisible by 30 so many encryption keys are reserved for terminal equipment AB, AC, AD, BC, BD, CD in pairs as they can form pairs. Hereby an encryption key S_N corresponding to each index N is distributed to one terminal equipment pair only.

Such an embodiment is also possible and can easily be deduced from the former, where there are not necessarily any entirely common encryption keys for the terminal equipment A-D, but the procedure of the kind presented above is implemented, for example, in some periodic manner. For BACK_UP keys, too, a similar key implementation in pairs only can be applied, where they have a separate table of their own.

Furthermore, the encryption keys S_N need not necessarily be in pairs, but the method may also be implemented in such a way that all terminal equipment but one get a certain encryption key. Hereby in the case of terminal equipment N the encryption key may be, for example, shared in three, four, five, . . . , N−1.

By such a division in advance of encryption keys S_N into partial groups, where only some keys S_N are distributed to some terminal equipment A-D, such an advantage is achieved, among others, that when the security level of a terminal equipment A becomes essentially poorer (for example, when it is stolen), there is no need to move over to the already presented reuse of encryption keys S_N, which may have a detrimental effect on the security level of encryption. Now the terminal equipment B-D with unchanged security level may continue with their secured communication, because they still have secured encryption key pairs with each terminal equipment B-D.

In addition, although the foregoing contains a presentation of communication between two terminal equipment A-D as an application example, the method according to the invention may be generalized straightforwardly for 1-to-N group communication between several terminal equipment A-D. The method according to the invention hereby provides an especially functioning and smooth implementation for carrying out the one-time pad encryption model, because in the method according to the invention the number of encryption keys need not necessarily depend, for example, on the size of the group of users 12.1-12.4.

In principle, the encrypted data may be any kind of digital information from electronic mail to GSM-encrypted speech, but since media-rich information consumes one-time pads at a higher rate, the invention is most advantageous in text messages, such as GSM-SMS communication, electronic mail or in simple images, such as maps (for example MMS).

The invention is ideal, for example, in such situations where business enterprises have international operations, transporting vehicles or large business premises, which are likely to be visited regularly by all users 12.1, 12.2, 12.3, 12.4 with their terminal equipment A-D.

A situation where the method according to the invention can be used by way of example is one where a company employee asks the main office for instructions in contract negotiations. Another example is a guard receiving a SMS message containing the address of an emergency object.

Other potential user groups for the method and system according to the invention are, for example, travelling representatives of companies, valuable transporting vehicles, vehicle fleets of taxi, ambulance and security firms, law offices and medical use (confidential remote consultation), personnel of airports, oil-drilling rigs, prisons and nuclear power stations and government use. Other examples of application objects are bank transactions over the telephone, whereby the Bluetooth hub may be located at the bank office; m-Commerce, that is, mobile commerce, whereby the Bluetooth hub may be located in a department store, at grass-root level, in private use of human rights and other groups, etc.

It should be understood that the above explanation and the relating figures are only intended to illustrate the method and system according to the present invention. Thus, the invention is not limited only to the embodiments presented above or those defined in the claims, but many such different variations and modifications will be obvious to the man skilled in the art, which are possible within the scope of the inventive idea defined by the appended claims.

1. Method in a digital wireless data communication network for arranging data encryption as one-time pad encryption, wherein the data communication network includes at least two terminal equipment (A, B), which terminal equipment (A, B) are used for managing a set of indexed encryption keys (SN) and the first terminal equipment (A) is at least a transmitter and the second terminal equipment (B) is at least a receiver and wherein the data encryption is adapted to take place at the first terminal equipment (A) in stages, wherein
an encryption key index (N) is chose
the data (M) to be transmitted is encrypted by using the encryption key defined by the chosen encryption key index (N) and
the encrypted data (RM) is transmitted to the second terminal equipment (B)
and wherein, correspondingly, the second terminal equipment (B) is used for
receiving the encrypted data (RM) and
decrypting the encrypted data (RM) by using the chosen key (S_N) indicated by the encryption key index (N),
characterized in that, besides the encrypted data (RM), the said encryption key index (N) is transmitted to the receiving terminal equipment (B) and the data communication network also includes a special server terminal equipment, which is arranged to manage and distribute a set of indexed encryption keys (S_N) to the terminal equipment (A, B).

2. Method according to claim 1, characterized in that, besides the said indexed encryption keys (S N), the identifier (ID) of its subordinated terminal equipment (A, B) is stored at the server terminal equipment, and wherein when updating a terminal equipment (A, B) at server terminal equipment
the terminal equipment (A, B) to be updated is identified
from the terminal equipment (A, B) at least one used encryption key index (N) is received, and
based on an established criterion a command is transmitted to one or more terminal equipment (A, B) to delete the corresponding one or more encryption key indexes (N),
and which is used to delete irrevocably the chosen index at the said terminal equipment (A, B).

3. Method according to claim 2, characterized in that with one or more terminal equipment (A, B, C) the following sub-stages are also connected with the updating
the said commands are received and carried out in order to delete the said one or more encryption key indexes (N),
acknowledgements are transmitted to the server of the deletion of one or more encryption key indexes (N).

4. Method according to claim 3, characterized in that furthermore in connection with updating at server terminal equipment
acknowledgements by at least one terminal equipment (A, B) are received of the deletion of one or more encryption key indexes (N) and based on an established second criterion,
one or more encryption key indexes (N) are deleted finally.

5. Method according to claim 1, characterized in that the encryption key index (N) is chosen by the transmitting terminal equipment (A), after which choice the terminal equipment (A) inquires from the server terminal equipment about the usability of the chosen index (N), and based on the information given it either approves the chosen index or chooses a new index for checking.

6. Method according to claim 1, characterized in that the encryption key index (N) is chosen by the server terminal equipment, whereby the transmitting terminal equipment (A) inquires from the server terminal equipment about the valid index (N), when transmitting to the receiving terminal equipment.

7. Method according to claim 1, characterized in that, the chosen encryption key (SN) is used only once.

8. Method according to claim 7, characterized in that as one sub-stage at least one of the communicating terminal equipment (A, B) immediately transmits information on the use of the encryption key index (N) to the server terminal equipment.

9. Method according to claim 1, characterized in that the encryption key (SN) corresponding to the said encryption key index (N) is used at least twice, whereby the terminal equipment (A, B) is used to maintain cycle information (TUSE N) on each used index (N) and the server terminal equipment is used to maintain total cycle information (USE N) on the indexes (N).

10. Method according to claim 9, characterized in that in connection with the updating of terminal equipment (A, B) at the server terminal equipment is used before the said deletion command also for
receiving from terminal equipment (A) cycle information (TUSEN) of at least one used encryption key index (N),
the received cycle information (TUSE N) is summed into the total cycle information (USE N), and
the total cycles (USE N) of the said one or more indexes (N) are compared with an established criterion value (MAX), based on which a decision is taken to carry out the said command to delete the index (N).

11. Method according to claim 1, characterized in that in addition at server terminal equipment when updating the encryption keys (SN) of terminal equipment (A, B)
at least one new encryption key index (N) is added to the terminal equipment (A, B) to be updated,
a corresponding encryption key (S N) is generated for one or more added indexes (N),
one or more indexes (N) and the corresponding encryption key (S N) are transmitted to the terminal equipment (A, B) to be updated.

12. Method according to claim 11, characterized in that at the server terminal equipment said encryption keys are generated in such a way that after the updating measures the terminal equipment (A, B) to be updated has at least one common encryption key (SN) with every other terminal equipment C, D).

13. Method according to claim 1, characterized in that the encryption keys (S_N) stored at the terminal equipment (A, B) are encrypted, whereby the encryption is decrypted before the data encryption is carried out and/or decrypted.

14. Method according to claim 1, characterized in that the encryption keys (S_N) are transferred encrypted from server terminal equipment to the terminal equipment (A-D).

15. Method according to claim 1, characterized in that when the security status of some terminal equipment (B) breaks down according to the established criterion, those encryption keys (S_N) are deleted from use, which are used at the corresponding terminal equipment (B).

16. System in a digital wireless data communication network for arranging data encryption as one-time pad encryption, which data communication network includes at least two terminal equipment (A, B) including
devices for storing and managing indexed encryption keys (S_N),
devices for carrying out data encryption and for decrypting the encryption with a chosen algorithm and with an encryption key (S-N) according to the encryption key index (N),
at least one bearer interface for receiving indexed encryption keys (S_N),
characterized in that at least one of the terminal equipment belonging to the data communication network functions as a special server terminal equipment, which manages and distributes encryption keys (S_N) to the other terminal equipment (A, B) according to an established criterion.

17. System according to claim 16, characterized in that the distribution of indexed encryption keys (S_N) to the terminal equipment (A, B) takes place over a wireless local area network connection, such as, for example, WLAN (Wireless Local Area Network) or Bluetooth.

18. System according to claim 16, characterized in that the distribution of indexed encryption keys (S-N) to the terminal equipment (A, B) takes place over a local data communication connection, such as, for example, IRDA (Infrared Data Association) or through a data cable connection.

19. Server terminal equipment in a digital wireless data communication network for arranging data encryption as one-time pad encryption, characterized in that at the server terminal equipment a set of indexed encryption keys (SN) is arranged as well as a functionality for management and distribution of the indexed encryption keys (S N).

20. Server terminal equipment according to claim 18, characterized in that at the server terminal equipment a functionality is arranged for optimizing the number of encryption keys (S_N) to be distributed to the terminal equipment (A-D) according to the current situation of use.
